(19) United States
(12) Patent Application Publication
(10) Pub. No.: US 2012/0162040 A1
(43) Pub. Date: Jun. 28, 2012

(54) MOBILE WIRELESS TERMINAL

(76) Inventors: Toru Taura, Tokyo (JP); Eiji Hankui, Tokyo (JP); Naoshi Kitamoto, Tokyo (JP)

(21) Appl. No.: 13/257,924

(22) PCT Filed: Feb. 26, 2010
(86) PCT No.: PCT/JP2010/001318

§ 371 Date: Mar. 16, 2012

(30) Foreign Application Priority Data
Mar. 23, 2009 (JP) 2009-069684

(51) Int. Cl. H01Q 21/28; H01Q 13/10

(52) U.S. Cl. 343/770; 343/893

(57) ABSTRACT

A mobile wireless terminal is provided which has an antenna constitution that does not have deterioration on a wireless function regardless of when a clamshell type chassis is opened or closed. In such a mobile wireless terminal, a first antenna element is set on a side of a inside surface of a display chassis, and a second antenna element is set on a side of an external surface. A first/second conductive board is arranged so as to face the first/second antenna element. When a display chassis and a main body chassis are in an opened state, both the first and second antennas work which are arranged in the display chassis. When a display chassis and a main body chassis are in a closed state, the second conductive board affects on the second antenna element so as to avoid effects of a metal of the main body chassis, and the second antenna element works without being affected from the metal of the main body chassis.

### BACKGROUND OF THE INVENTION

1. Technical Field

The present invention relates to a mobile wireless terminal. In particular, the present invention relates to a mobile wireless terminal including an antenna constitution which can avoid deterioration on a wireless communication function when a clamshell type chassis is opened or closed.

Priority is claimed on Japanese Patent Application No. 2009-069684,, filed Mar. 23, 2009, the content of which is incorporated herein by reference.

1. Background Art

While mobile wireless terminals have been becoming smaller and thinner, there is a tendency in which a metallic chassis is used to provide rigidity of a terminal.

On the other hand, an antenna mounted on the mobile wireless terminal has been becoming installed inside the chassis due to design and problems of damages. However, if a chassis is completely made from a metal, the antenna inside the chassis does not work. Therefore, a technique is disclosed in which a portion of the chassis around the antenna is non-metallic. For example, Patent Document 1 describes a constitution in which a chassis's material around an antenna is made from a resin. Both a metallic vessel arranged at an outside periphery of a display device and a wireless antenna attached to the metallic vessel are installed inside a metallic chassis such as magnesium. In other words, in such a constitution, only a portion corresponding to the wireless antenna is replaced by a non-metallic material such as a synthetic resin which does not block the radio waves.

Further, Patent Document 2 describes a constitution in which an antenna is mounted on each of a pair of clamshell type chassis, and in which a currently used antenna is switched in accordance with open/close operation of the chassis. Due to this, the antenna used when the chassis is opened and used when the chassis is closed is switched so as to avoid deterioration of a wireless function.
[Patent Document 1] Japanese Patent Application, First Publication No. 2006-303911
[Patent Document 2] Japanese Patent Application, First Publication No. 2004-244260

### SUMMARY OF THE INVENTION

However, a technique of Patent Document 1 has a problem in which, when the chassis is closed or folded, one of the chassis in which the antennas are mounted is close to other chassis, and the antenna characteristics are fluctuated due to the influence of components of other chassis. If a chassis's material of the other chassis is metallic, the antenna touches the metal of other chassis when the chassis are folded or closed. Therefore, there are large amount of influence on the characteristics, a frequency band in which the antenna works is largely fluctuated, and due to this, there is a problem in which it is not possible to use the wireless function when the chassis is folded or closed.

Further, a technique described in Patent Document 2 has a problem in which the characteristics of the antennas are changed between the time when the chassis is opened and the time when the chassis is closed due to changes of the distance between the antennas. Particularly in recent years, mobile terminals have been becoming comparatively small, and the antennas are close to each other when the chassis is closed or folded. Due to this, a frequency band in which the antennas work is largely fluctuated because the characteristics of the wireless antennas are heavily influenced, and therefore, there is a problem in which it is not possible to use the wireless function when the chassis is folded or closed.

The present invention is conceived based on such technical problems and has an object to provide a mobile wireless terminal having an antenna constitution in which the wireless function does not deteriorate regardless of when a clamshell type chassis is opened or closed.

A mobile wireless terminal of the present invention which is conceived to resolve such an object is characterized by including: a first chassis including an antenna portion; and a second chassis which includes a metallic portion and which is rotatably connected to an end portion of the first chassis, wherein the mobile wireless terminal is transformable to at lease both a closed state in which the metallic portion is close to the antenna portion when the first and second chassis are overlapped and an opened state in which the metallic portion and the antenna portion are separated by rotatably moving the second chassis from the closed state, the antenna portion includes: a first conductive board when in the closed state, which is arranged on an outer side compared to a first antenna which is on the second chassis while the first conductive board faces against the first antenna; a second antenna which is arranged on the outer side when in the closed state; and a second conductive board which is arranged on the second chassis and which faces the second antenna.

In accordance with the present invention, when the first and second chassis are opened, the first and second antenna can be used so as to function as a non-directional antenna which has omnidirectional sensitivity. Further, when the first and second chassis are closed, the first antenna is closely arranged to a metallic portion of the second chassis and does not work as an antenna. On the other hand, in such a condition, the second antenna has effects of a conductive board which avoid the influence from the metallic portion of the second chassis. Therefore, the second antenna works without being affected by the metallic portion. Hence, the antenna stably works regardless of when the chassis is opened or closed, and the wireless function is not deteriorated.

### BRIEF DESCRIPTION OF THE DRAWINGS

FIG. 1A is an oblique perspective drawing of opened chassis for explaining the constitution of a mobile wireless terminal of a first embodiment.

FIG. 1B is a left side drawing of opened chassis for explaining the constitution of a mobile wireless terminal of the first embodiment.

FIG. 1C is a right side drawing of opened chassis for explaining the constitution of a mobile wireless terminal of the first embodiment.

FIG. 1D is a left side drawing of closed chassis for explaining the constitution of a mobile wireless terminal of the first embodiment.

FIG. 1E is a right side drawing of closed chassis for explaining the constitution of a mobile wireless terminal of the first embodiment.

FIG. 2A is a plane drawing showing antenna directivity of a mobile wireless terminal of FIGS. 1A-1E when the chassis is opened.

FIG. 2B is a side drawing showing antenna directivity of a mobile wireless terminal of FIGS. 1A-1E when the chassis is opened.

FIG. 2C is a side drawing showing antenna directivity of a mobile wireless terminal of FIGS. 1A-1E when the chassis is closed.

FIG. 3A is an oblique perspective drawing of opened chassis for explaining the constitution of a mobile wireless terminal of a second embodiment.

FIG. 3B is a left side drawing of opened chassis for explaining the constitution of a mobile wireless terminal of the second embodiment.

FIG. 3C is a right side drawing of opened chassis for explaining the constitution of a mobile wireless terminal of the second embodiment.

FIG. 3D is a left side drawing of closed chassis for explaining the constitution of a mobile wireless terminal of the second embodiment.

FIG. 3E is a right side drawing of closed chassis for explaining the constitution of a mobile wireless terminal of the second embodiment.

FIG. 3F is a left side drawing of chassis opened in tablet form for explaining the constitution of a mobile wireless terminal of the second embodiment.

FIG. 3G is a right side drawing of chassis opened in tablet form for explaining the constitution of a mobile wireless terminal of the second embodiment.

FIG. 4A is a plane drawing showing antenna directivity of a mobile wireless terminal of FIGS. 3A-3G when the chassis is opened.

FIG. 4B is a side drawing showing antenna directivity of a mobile wireless terminal of FIGS. 3A-3G when the chassis is opened.

FIG. 4C is a side drawing showing antenna directivity of a mobile wireless terminal of FIGS. 3A-3G when the chassis is closed.

FIG. 4D is a side drawing showing antenna directivity of a mobile wireless terminal of FIGS. 3A-3G when the chassis is opened in tablet form.

FIG. 5 is an oblique perspective drawing for explaining the constitution of a mobile wireless terminal of a third embodiment.

FIG. 6 is an oblique perspective drawing for explaining the constitution of a mobile wireless terminal of a fourth embodiment.

FIG. 7A is an oblique perspective drawing for explaining the constitution of a mobile wireless terminal of a fifth embodiment.

FIG. 7B is a drawing showing a circuit constitution of an antenna switching portion of a mobile wireless terminal for explaining the constitution of a mobile wireless terminal of the fifth embodiment.

FIG. 8A is an oblique perspective drawing for explaining the constitution of a mobile wireless terminal of a sixth embodiment.

FIG. 8B is a drawing showing a circuit constitution of an antenna switching portion of a mobile wireless terminal for explaining the constitution of a mobile wireless terminal of the sixth embodiment.

FIG. 9 is an oblique perspective drawing for explaining the constitution of a mobile wireless terminal of a seventh embodiment.

FIG. 10 is an oblique perspective drawing for explaining the constitution of a mobile wireless terminal of an eighth embodiment.

### DETAILED DESCRIPTION OF THE INVENTION

### Embodiment 1

Hereinafter, in reference to the drawings, best mode embodiments for implementing mobile wireless terminals of the present invention are explained. However, the present invention is not limited only to these embodiments.

### First Embodiment

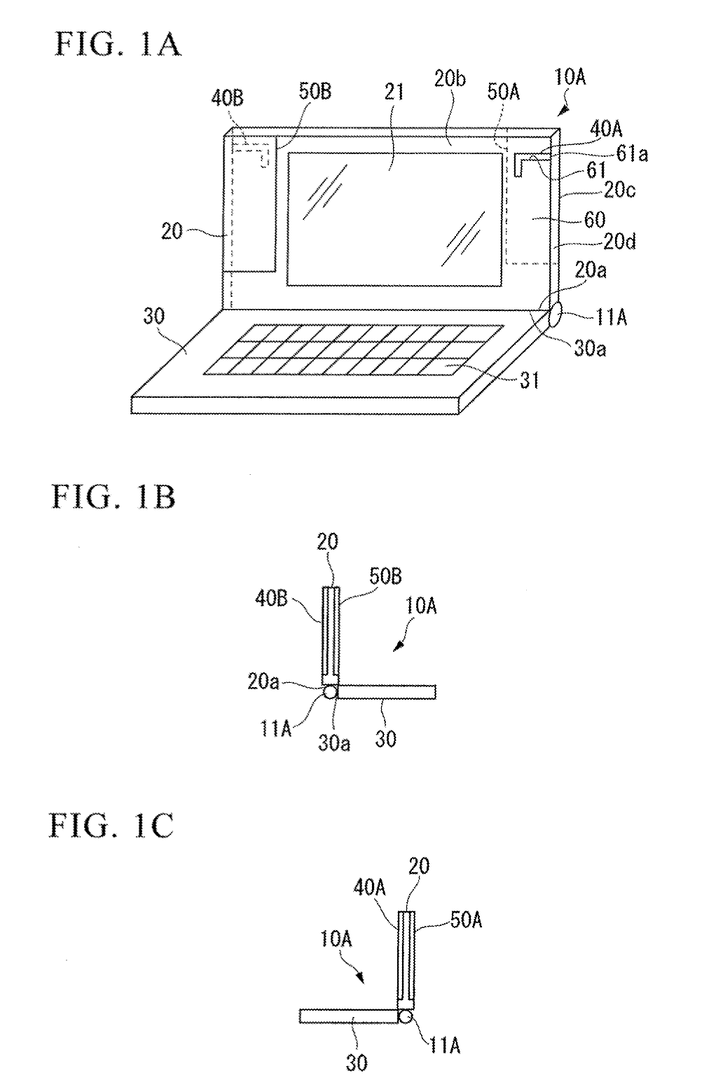

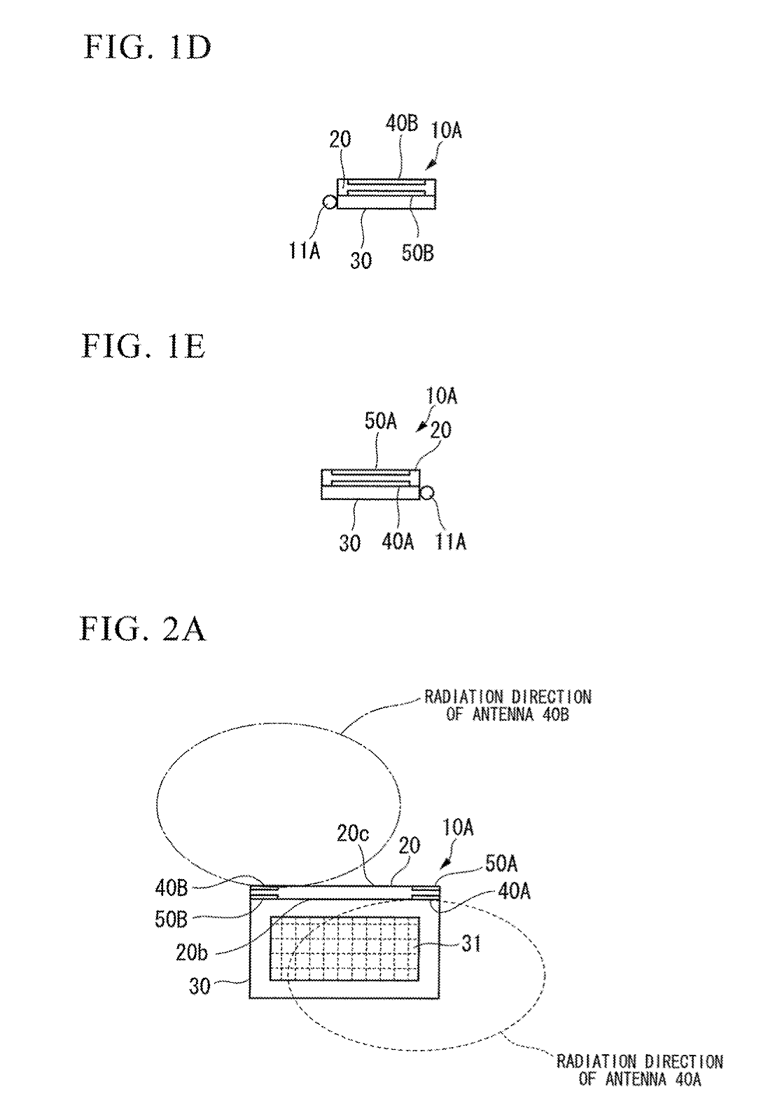

FIGS. 1A-1E are drawings for explaining a constitution of a mobile wireless terminal 10A of this embodiment, FIG. 1A is an oblique perspective drawing in which a display chassis 20 and a main body chassis 30 are opened, FIG. 1B is a left side drawing in which the display chassis 20 and the main body chassis 30 is opened, FIG. 1C is a right side drawing in which the display chassis 20 and the main body chassis 30 are opened, FIG. 1D is a left side drawing in which the display chassis 20 and the main body chassis 30 is closed, and FIG. 1E is a right side drawing in which the display chassis 20 and the main body chassis 30 is closed.

As shown in FIGS. 1A-1E, the mobile wireless terminal 10A has: a display chassis (first chassis) 20 which has a display portion such as a LCD and which is metallic; and a main body chassis (second chassis) 30 which has a key input portion (input portion) 31 and which is metallic.

Such display chassis 20 and main body chassis 30 are connected at respective edges 20a and 30a so as to be relatively rotatable via a hinge portion 11A, and it is possible to transform between a closed state in which the display chassis 20 and the main body chassis 30 are overlapped as shown in FIGS. 1D and 1E and an open state in which an inside surface 20b on which the display portion 21 of the display chassis 20 is formed and a surface on which the key input portion 31 of the main body chassis 30 is formed are separated or divided as shown in FIGS. 1A-1C by conducting a respective rotation of the main body chassis 30 against the display chassis 20 from the closed state.

On the display chassis 20, an antenna portion is provided which is constituted from antenna elements 40A and 40B and conductive boards 50A and 50B.

The antenna elements 40A and 40B are set at both sides of the display portion 21. One of the antenna elements 40A and 40B (in this embodiment, the antenna element (first antenna) 40A) is set on a side of the inside surface 20b (on a side on which a display surface of the display portion 21 is formed) which faces the key input portion 31 of the main body chassis 30, and the rest of the antenna elements 40A and 40B (in this embodiment, the antenna element (second antenna) 40B) is arranged so as to be on a side of an external surface 20c (outer side when in a closed state).

Here, on a metallic board 60 which is arranged so as to be along the inside surface 20b of the display chassis 20, it is possible to form the antenna elements 40A/40B by forming a slot antenna which is, for example, a slot (slit) 61 in a L-shape having an electric length corresponding to one fourth of a wavelength of a working frequency. It is possible to form the metallic board 60 so as to be independently provided from the display chassis 20, however, it is preferable to form the metallic board 60 in an integrated manner with a metal which forms the inside surface 20b of the display chassis 20. Here, the slot 61 is formed in a manner in which an open end 61a faces a side face portion 20d of the display chassis 20, and the display chassis 20 has the side face portion 20d on which the open end 61a of the slot 61 is arranged and which is formed by using a resin.

Here, a shape of the slot 61 is the L-shape in the above description, however, this is not a limitation, and it is possible to apply a straight shape or a meander shape. Further, the number of the slot 61 formed on the metallic board 60 is not limited to one, and it is possible to apply a multi-resonant constitution including multiple slots. Further, the constitution of the slot 61 including one open end 61a is not a limitation, and it is possible to provide a pair of short-circuited ends while the slot has an electric length of a half of the wavelength of the working frequency.

Further, on the display chassis 20, on surfaces facing the antenna elements 40A and 40B, the conductive boards 50A and 50B made from a conductive material are provided. In other words, the conductive board (first conductive board) 50A facing the antenna element 40A is provided on a side of an external surface 20c (outer side when in a closed state) which is on an opposite side of the antenna element 40A of the display chassis 20, and the conductive board (second conductive board) 50B facing the antenna element 40B is provided on a side of an internal surface 20b (on a side facing the key input portion 31 of the main body chassis 30) which is on an opposite side of the antenna element 40B of the display chassis 20

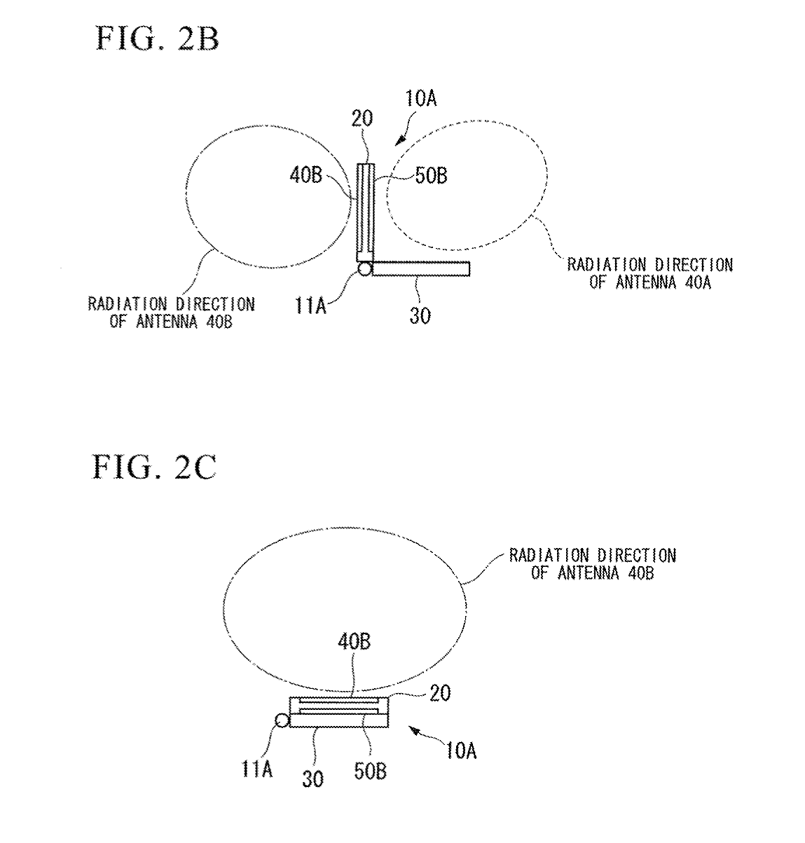

As shown in FIGS. 1B, 1C, 2A and 2B, in the above-described mobile wireless terminal 10A, when the display chassis 20 and the main body chassis 30 are in an opened state, a pair of antenna elements 40A and 40B provided on the display chassis 20 respectively have strong directivity along directions opposite to the directive boards 50A and 50B. Therefore, it is possible to provide a function of a non-directional antenna which has directivity along all directions by combining the antenna elements 40A and 40B.

Further, as shown in FIGS. 1D, 1E and 2C, when the display chassis 20 and the main body chassis 30 are closed, the antenna element 40A practically does not work as an antenna because the antenna element 40A is close to the metal which constitutes the main body chassis 30, and on the other hand, the antenna element 40B is available without being affected by the metal of the main body chassis 30 because the conductive board 50B affects on the antenna element 40B so as to avoid effects of the metal of the main body chassis 30. Therefore, in the mobile wireless terminal 10A of this embodiment, the antenna works regardless of when the display chassis 20 and the main body chassis 30 are opened/closed, and it is possible to avoid deterioration of the wireless function.

### Second Embodiment

Hereinafter, a second embodiment of the mobile wireless terminal is explained. It should be noted that in the following description, the same reference numerals are applied to the same constitutional elements as the above-described first embodiment, and explanations of such constitutional elements are omitted.

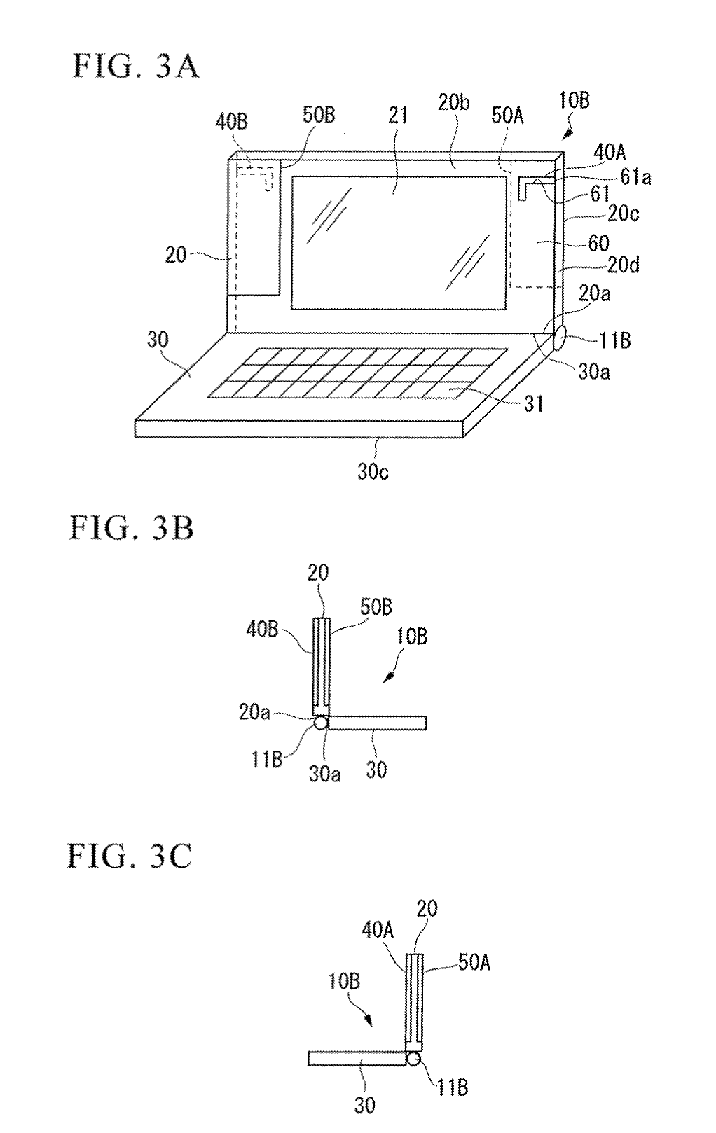

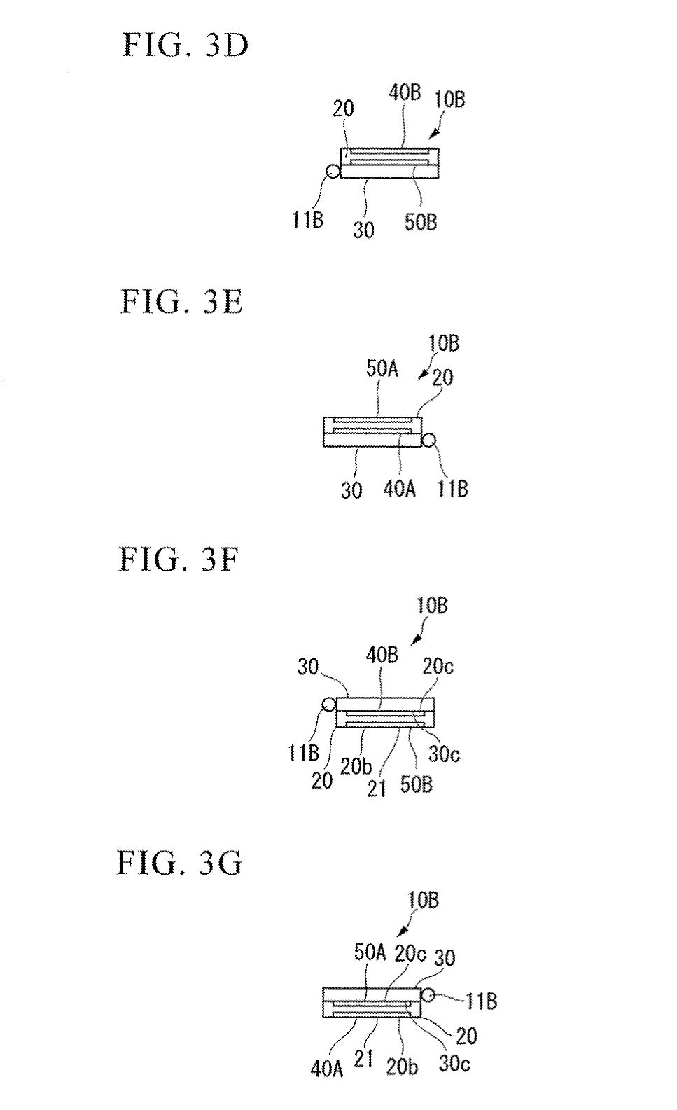

FIGS. 3A-3G are drawings for explaining a constitution of a mobile wireless terminal 10B of this embodiment, FIG. 3A is an oblique perspective drawing in which a display chassis 20 and a main body chassis 30 are opened, FIG. 3B is a left side drawing in which the display chassis 20 and the main body chassis 30 are opened, FIG. 3C is a right side drawing in which the display chassis 20 and the main body chassis 30 are opened, FIG. 3D is a left side drawing in which the display chassis 20 and the main body chassis 30 are closed, FIG. 3E is a right side drawing in which the display chassis 20 and the main body chassis 30 are closed, FIG. 3F is a left side drawing in which the display chassis 20 and the main body chassis 30 are opened in tablet form, and FIG. 3G is a right side drawing in which the display chassis 20 and the main body chassis 30 are opened in tablet form.

The mobile wireless terminal 10B described in this embodiment has the same constitution as the mobile wireless terminal 10A described in the first embodiment other than a point in which the mobile wireless terminal 10B has a hinge portion 11B around that a respective rotation operation between the display chassis 20 and the main body chassis 30 at 360 degrees is possible.

In other words, the display chassis 20 and the main body chassis 30 of the mobile wireless terminal 10B can be transformed to be in an opened state as shown in FIGS. 3B and 3C, a closed state as shown in FIGS. 3D and 3E and an opened state in so-called tablet form as shown in FIGS. 3F and 3G in that while the display portion 21 is on the outside, the external surface 20c of the display chassis 20 faces a back surface 30c that is an opposite side of the key input portion 31 of the main body chassis 30.

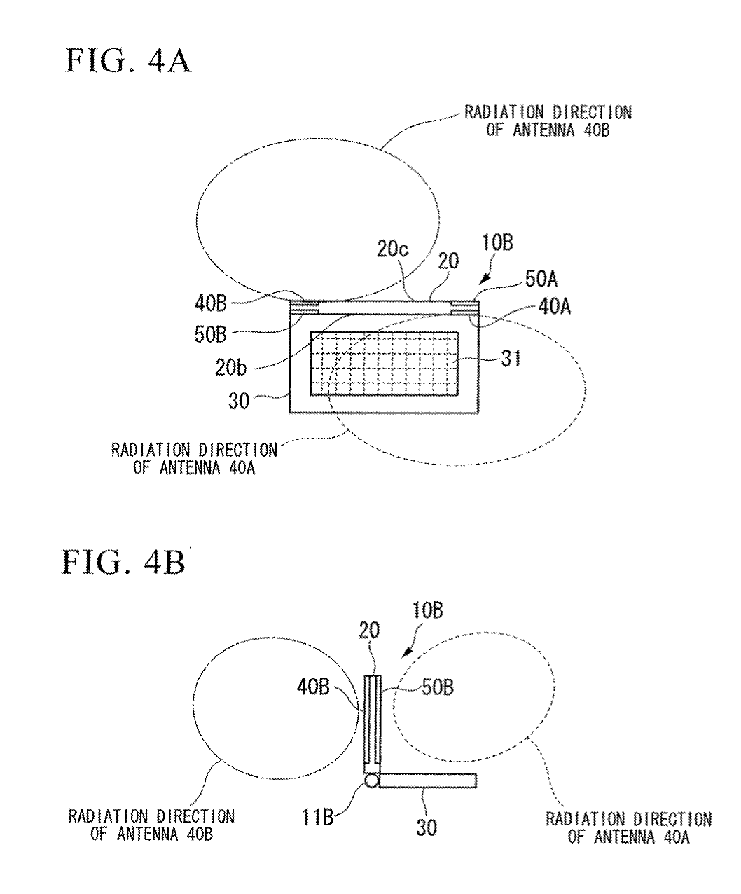

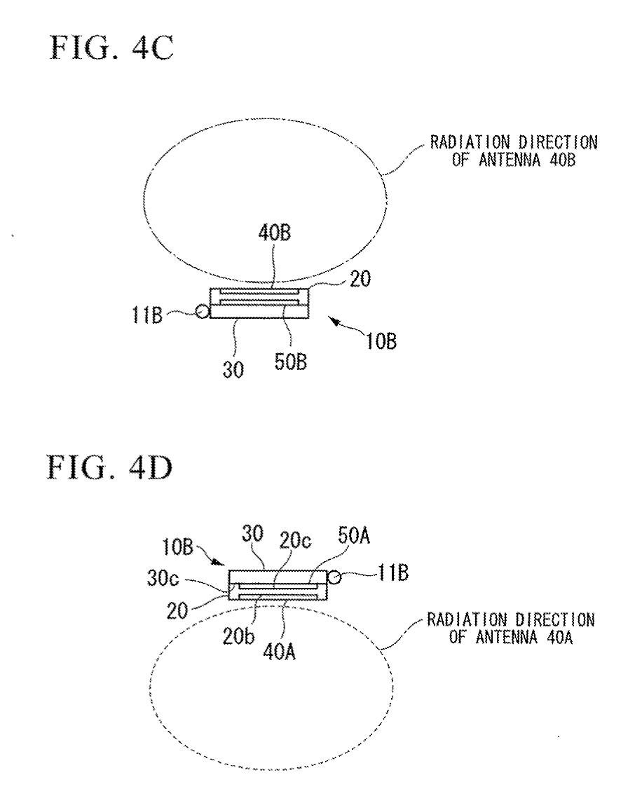

As shown in FIGS. 3B, 3C, 4A and 4B, in the mobile wireless terminal 10B described in this embodiment, when the display chassis 20 and the main body chassis 30 are in an opened state, a pair of antenna elements 40A and 40B provided on both sides of the display portion 21 respectively have strong directivity along directions opposite to the directive boards 50A and 50B. Therefore, it is possible to provide a function of a non-directional antenna which has directivity along all directions by combining the antenna elements 40A and 40B.

Further, as shown in FIGS. 3D, 3E and 4C, when the display chassis 20 and the main body chassis 30 are closed, the antenna element 40A practically does not work as an antenna because the antenna element 40A is close to the metal of the main body chassis 30, and on the other hand, the antenna element 40B is available without being affected by the metal of the main body chassis 30 because the conductive board 50B affects on the antenna element 40B so as to avoid effects of the metal which constitutes the main body chassis 30.

Further, as shown in FIGS. 3F, 3G and 4D, when the display chassis 20 and the main body chassis 30 are opened in tablet form, the antenna element 40B practically does not work as an antenna because the antenna element 40B is close to the metal of the main body chassis 30, and on the other hand, the antenna element 40A is available without being affected by the metal of the main body chassis 30 because the conductive board 50A affects the antenna element 40A so as to avoid effects of the metal which constitutes the main body chassis 30.

Therefore, in the mobile wireless terminal 10B of this embodiment, the antenna works regardless of when the display chassis 20 and the main body chassis 30 are opened, closed and opened in tablet form, and it is possible to avoid deterioration of the wireless function.

In the above-described first and second embodiments, the antenna elements 40A and 40B are constituted by forming the slot 61 on the metallic board 60, however, in place to such embodiments, it is possible to use constitutions described in the following third and fourth embodiments.

### Third Embodiment

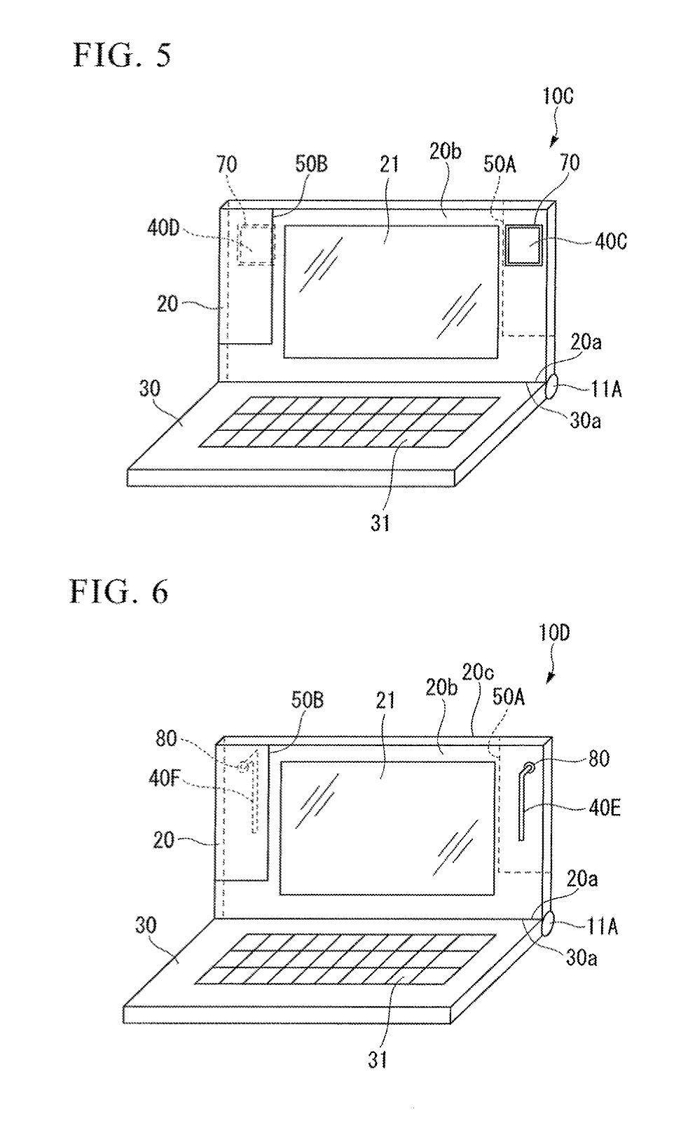

FIG. 5 shows a third embodiment of the mobile wireless terminal. This embodiment provides antenna elements 40C and 40D which are used in place to the antenna elements 40A and 40B described in the first and second embodiments. It should be noted that in the following description, the same reference numerals are applied to the same constitutional elements as the above-described first and second embodiments, and explanations of such constitutional elements are omitted here.

As shown in FIG. 5, in a mobile wireless terminal 10C, the antenna elements 40C and 40D are set at both sides of the display portion 21. One of the antenna elements 40C and 40D (in this embodiment, the antenna element 40C) is set on a side of the inside surface 20b of the display chassis 20 (on a side on which a display surface of the display portion 21 is formed), and the rest of the antenna elements 40C and 40D (in this embodiment, the antenna element 40D) are arranged so as to be on a side of an external surface 20c. Further, conductive boards 50A and 50B made from a conductive material are provided on both sides of the display chassis 20 that face the antenna elements 40C and 40D.

The antenna elements 40C and 40D are flat antennas that have a patch shape facing the conductive boards 50A and 50B. The antenna elements 40C and 40D constituted from the flat antennas are insulated from the metal which constitutes the display chassis 20 by using an insulation material 70 which is, for example, a resin.

It should be noted that the shape of the antenna elements 40C and 40D is not limited to the rectangular shape shown in FIG. 5, and it is possible to have, for example, a circular shape or a shape including a slit. Further, it is possible to constitute the antenna elements 40C and 40D by multiple flat antennas so as to have a multi-resonant constitution.

In the above-described mobile wireless terminal 10C, the antenna elements 40C and 40D constituted from flat antennas have excitation due to the electric power supplied from an RF circuit (not shown in the drawings) and have a resonance at a frequency which is dependent on the size of the flat antennas. In such a case, the display chassis 20 including the conductive boards 50A and 50B has a function of a ground of the flat antennas. Therefore, the antenna elements 40C and 40D mounted on the mobile wireless terminal 10C of this embodiment have directivity in directions which are on the sides of the antenna elements 40C and 40D.

In the above-described mobile wireless terminal 10C, when the display chassis 20 and the main body chassis 30 are in an opened state, at least the antenna element 40A works, and when the display chassis 20 and the main body chassis 30 are opened in tablet form, the antenna element 40A works. When the display chassis 20 and the main body chassis 30 are in a closed state, the antenna element 40B works. Therefore, in the mobile wireless terminal 100 of this embodiment, the antenna works regardless of when the display chassis 20 and the main body chassis 30 are opened, closed and opened in tablet form, and it is possible to avoid deterioration of the wireless function.

### Fourth Embodiment

FIG. 6 shows Fourth embodiment of the mobile wireless terminal. This embodiment provides antenna elements 40E and 40F which are used in place to the antenna elements 40A and 40B described in the first and second embodiments. It should be noted that in the following description, the same reference numerals are applied to the same constitutional elements as the above-described first and second embodiments, and explanations of such constitutional elements are omitted here.

As shown in FIG. 6, in a mobile wireless terminal 10D, the antenna elements 40C and 40D are set at both sides of the display portion 21. One of the antenna elements 40E and 40F (in this embodiment, the antenna element 40E) is set on a side of the inside surface 20b of the display chassis 20 (on a side on which a display surface of the display portion 21 is formed), and the rest of the antenna elements 40E and 40F (in this embodiment, the antenna element 40F) is arranged so as to be on a side of an external surface 20c. Further, conductive boards 50A and 50B made from a conductive material are provided on both sides of the display chassis 20 that face the antenna elements 40E and 40F.

The antenna elements 40E and 40F are thin and long wire antennas made from a metallic material facing the conductive boards 50A and 50B, and such wire antenna elements are insulated from the metal which constitutes the display chassis 20 by using an insulation material 80 which is, for example, a resin.

It should be noted that in FIG. 6, the antenna elements 40E and 40F are in a reversed L-shape, however, such a shape is not a limitation, and it is possible to apply, for example, a meander shape or a reversed F-shape in which a short circuit board is inserted between the conductive boards 50A and 50B. Further, it is possible to constitute the antenna elements 40E and 40F from multiple wire antenna elements so as to have a multi-resonant constitution.

In the above-described mobile wireless terminal 10D, the antenna elements 40E and 40F constituted from wire antenna elements have excitation due to the electric power supplied from an RF circuit (not shown in the drawings) and have a resonance at a frequency which is dependent on a size of the wire antenna elements. In such a case, the display chassis 20 including the conductive boards 50A and 50B has a function of a ground of the antenna elements 40E and 40F. Therefore, the antenna elements 40E and 40F mounted on the mobile wireless terminal 10D of this embodiment have directivity in directions which are on the sides of the wire antenna elements.

In the above-described mobile wireless terminal 10D, when the display chassis 20 and the main body chassis 30 are in an opened state, at least the antenna element 40A works, and when the display chassis 20 and the main body chassis 30 are opened in tablet form, the antenna element 40A works. When the display chassis 20 and the main body chassis 30 are in a closed state, the antenna element 40B works. Therefore, in the mobile wireless terminal 10D of this embodiment, the antenna works regardless of when the display chassis 20 and the main body chassis 30 are opened, closed and opened in tablet form, and it is possible to avoid deterioration of the wireless function.

### Fifth Embodiment

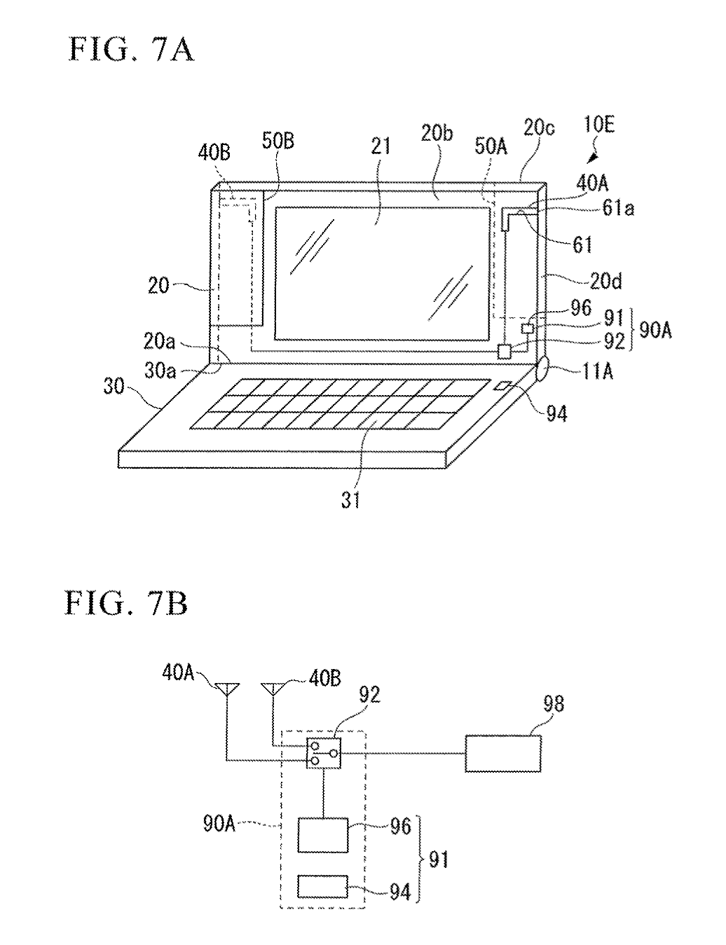

Hereinafter, a fifth embodiment of the mobile wireless terminal is explained. It should be noted that in the following description, the same reference numerals are applied to the same constitutional elements as the above-described first to fourth embodiments, and explanations of such constitutional elements are omitted here. FIGS. 7A and 7B are oblique perspective drawings for explaining the constitution of a mobile wireless terminal 10E of this embodiment.

As shown in these FIGS. 7A and 7B, the mobile wireless terminal 10E of this embodiment has an antenna switching portion 90A which switches the antenna to be used and which is set between antenna elements 40A/40B (40C/40D or 40E/40F) and an RF circuit 98.

The constitution of the antenna switching portion 90A includes: an open/close sensor 91 which detects an open/close state of both the display chassis 20 and the main body chassis 30; and an antenna switch 92 which switches between connections from the antenna element 40A to the RF circuit and from the antenna 40B to the RF circuit.

A constitution of the open/close sensor 91 includes: a magnet 94 arranged right below an opening portion which is formed on a portion of a metal that constitutes the main body chassis 30; and a Hall device 96 which is arranged right below an opening portion which is formed on a portion of a metal that constitutes the display chassis 20 and which detects a magnetic force, wherein the magnet 94 and the Hall device 96 are arranged so as to face each other when the display chassis 20 and the main body chassis 30 are in a closed state.

The Hall device 96 of the open/close sensor 91, by detecting no magnetic force from the magnet 94 when the display chassis 20 and the main body chassis 30 are in an opened state and by detecting the magnetic force from the magnet 94 which is facing when the display chassis 20 and the main body chassis 30 are in a closed state, detects the open/close state of the display chassis 20 and the main body chassis 30, and transmits an open/close signal to the antenna switch 92.

The antenna switch 92 receives the signal from the open/close sensor 91, selects the antenna element 40A when the display chassis 20 and the main body chassis 30 are in an opened state, selects the antenna element 40B when the display chassis 20 and the main body chassis 30 are in a closed state and switches excitations caused by an electric power supply from the RF circuit 98.

Further, with an open/close sensor which detects when the display chassis 20 and the main body chassis 30 are opened in tablet shape, it is possible to constitute the antenna switching portion 90A which detects three states including an opened state, a closed state and an opened state in tablet shape of the display chassis 20 and the main body chassis 30. In such a case, the magnets 94 which constitute the open/close sensor 91 are arranged right below opening portions that are formed on the metal of both front a side and a back side of the main body chassis 30, and the Hall devices 96 are set right below the opening portions formed on the metal of both a front side and a back side of the display chassis 20.

The antenna switch 92 receives the signal from the open/close sensor 91 conducts operation in a manner of selecting at least the antenna element 40A when the display chassis 20 and the main body chassis 30 are in an opened state, selecting the antenna element 40A when the display chassis 20 and the main body chassis 30 are in an opened state in tablet shape and selecting the antenna element 40B when the display chassis 20 and the main body chassis 30 are in a closed state.

### Sixth Embodiment

Hereinafter, a sixth embodiment of a mobile wireless terminal which is a modified example of the above-described fifth embodiment is explained. It should be noted that in the following description, the same reference numerals are applied to the same constitutional elements as the above-described first to fifth embodiments, and explanations of such constitutional elements are omitted.

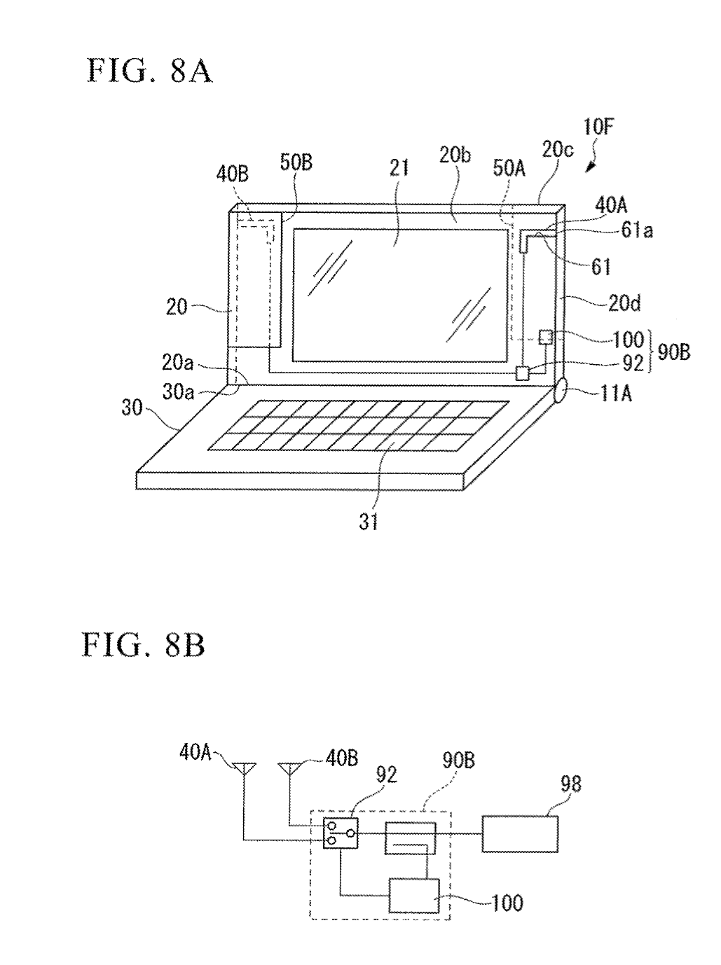

As shown in FIGS. 8A and 8B, a mobile wireless terminal 10F shown in an example of this embodiment includes a measurement portion 100 which, in place to the open/close sensor 91 of the above-described fifth embodiment, detects the reflected electric power from the antenna elements 40A/40B to detect an open/close state of the display chassis 20 and the main body chassis 30, and other constitutional elements are the same as the mobile wireless terminal 10E of the above-described fifth embodiment.

In other words, the mobile wireless terminal 10F has an antenna switching portion 90B which is arranged between the antenna elements 40A/40B (40C/40D or 40E/40F) and the RF circuit 98 and which includes the measurement portion 100.

Here, to efficiently operate the antenna elements 40A/40B, it is necessary to adjust the impedance between the antenna elements 40A/40B and the RF circuit 98. Such impedance is generally set 50Ω.

When the display chassis 20 and the main body chassis 30 are in an opened state, the antenna elements 40A and 40B are not affected by the metal of the main body chassis 30, and there is a small amount of reflected electric power because the impedance at the antenna element 40B is maintained to be close to 50Ω.

When the display chassis 20 and the main body chassis 30 are closed, the antenna element 40A is close to the metal of the main body chassis 30, and therefore, the reflected electric power from the antenna element 40A increases because the impedance of the antenna element 40A is greatly different from 50Ω. On the other hand, the antenna element 40B is available without being affected by the metal of the main body chassis 30 because the conductive board 50B affects the antenna element 40B so as to avoid effects of the metal of the main body chassis 30, and the reflected electric power from the antenna element 40B is small because the impedance at the antenna element 40B is maintained so as to be close to 50Ω.

The measurement portion 100 of this embodiment detects (changes of) an amount of the reflected electric power caused by an inconsistency of the above-described impedance between the antenna elements 40A/40B and the RF circuit 98 and transmits an open/close signal corresponding to the display chassis 20 and the main body chassis 30 to the antenna switch 92. The antenna switch 92 receives the signal from the measurement portion 100 and conducts operation in a manner of selecting the antenna element 40A when the display chassis 20 and the main body chassis 30 are in an opened state and selecting the antenna element 40B when the display chassis 20 and the main body chassis 30 are in a closed state.

In this embodiment, a constitution and operations of the antenna switching portion 90B are described when the display chassis 20 and the main body chassis 30 are in an opened state and/or in a closed state, and it should be noted that it is possible to apply the measurement portion 100 which constitutes the antenna switching portion 90B to a case in which the display chassis 20 and the main body chassis 30 are in an opened state in tablet shape.

When the display chassis 20 and the main body chassis 30 are in an opened state in tablet shape, the antenna element 40B is close to the metal of the main body chassis 30, and therefore, the reflected electric power from the antenna element 40B increases because the impedance of the antenna element 40A is largely different from 50Ω. On the other hand, the antenna element 40B is available without being affected by the metal of the main body chassis 30 because the conductive board 50A affects on the antenna element 40A so as to avoid effects of the metal of the main body chassis 30, the reflected electric power from the antenna element 40A is small because the impedance at the antenna element 40A is maintained so as to be close to 50Ω.

Therefore, the antenna switch 92 receives the signal from the measurement portion 100 and conducts operation in a manner of selecting at least the antenna element 40A when the display chassis 20 and the main body chassis 30 are in an opened state, selecting the antenna element 40A when the display chassis 20 and the main body chassis 30 are in an opened state in tablet shape and selecting the antenna element 40B when the display chassis 20 and the main body chassis 30 are in a closed state.

### Seventh Embodiment

Hereinafter, a seventh embodiment of a mobile wireless terminal is explained. It should be noted that in the following description, the same reference numerals are applied to the same constitutional elements as the above-described first to sixth embodiments, and explanations of such constitutional elements are omitted.

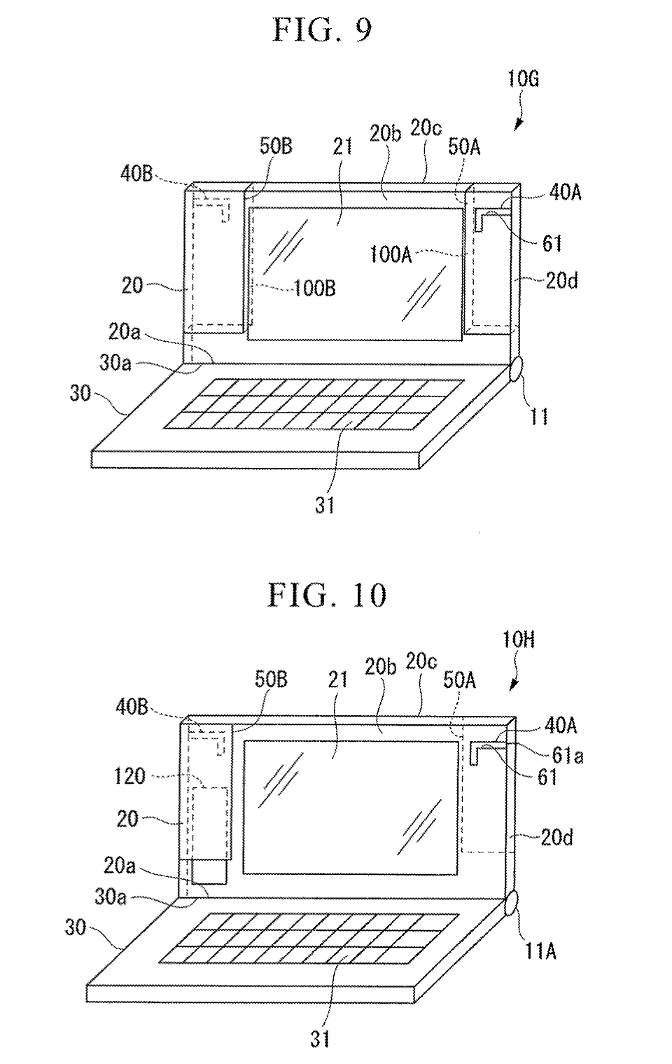

FIG. 9 is an oblique perspective drawing for explaining a constitution of a mobile wireless terminal 10G of this embodiment.

As shown in FIG. 9, in the mobile wireless terminal 10G of this embodiment, between the antenna element 40A and the display portion 21 and between the antenna element 40B and the display portion 21, in a vertical direction of the display chassis 20, a metallic wall 110A which electrically connects the conductive board 50A to the antenna element 40A and a metallic wall 110B which electrically connects the conductive board 50B to the antenna element 40B are included. Other constitutional elements are the same as in the above-described first embodiment.

For example, the display portion 21, for example, an LCD; the RF circuit 98 which conducts operations on high-frequency signals; a CPU, including peripheral devices that conduct operations on fast digital signals; and a power supply circuit which deals with a large amount of electric power, generally generate electro-magnetic noises between a wide frequency range, and the antenna reception performance is deteriorated because such noises are received by the antenna elements 40A and 40B. Conversely, when a transmission operation is conducted via the antenna elements 40A and 40B, the operation state of the circuit is unstable because the antennas 40A and 40B use a large amount of electric power, and the electro-magnetic waves are radiated and cause interference on the above-described peripheral devices and the circuit.

In addition, as described in this embodiment, the metallic walls 110A/110B have an effect of shielding walls because the metallic walls 110A/110B are arranged around the antenna elements 40A/40B, and it is possible to reduce electro-magnetic interference between the antenna elements 40A/40B and the display portion 21 and between the antenna elements 40A/40B and various circuits. Therefore, it is possible to maintain operations of the antenna elements 40A/40B and preferable operations of the display portion 21 and various circuits close to the antenna elements 40A/40B.

### Eighth Embodiment

Hereinafter, an eighth embodiment of a mobile wireless terminal is explained.

It should be noted that in the following description, the same reference numerals are applied to the same constitutional elements as the above-described first to seventh embodiments, and explanations of such constitutional elements are omitted here.

FIG. 10 is an oblique perspective drawing for explaining the constitution of a mobile wireless terminal 10H of this embodiment.

As shown in FIG. 10, the mobile wireless terminal 10H includes a display circuit portion 120 which drives/controls the display portion 21, the display circuit portion 120 is arranged between the antenna element 40A which is set on a side of the display portion 21 and the conductive board 50A, and the display circuit portion 120 is set at a position which is offset or sheared in a direction along the inside surface 20b of the display chassis 20. Other constitutional elements are the same as any one of the mobile wireless terminal 10A-10F of the above-described first to sixth embodiments.

In general, if a mounted component such as a circuit component is arranged close to an antenna element, there is a risk of deteriorating performance due to influence on the characteristics of the antenna. Further, there is a risk in which the mounted component conducts a wrong operation on a circuit because the interference of the strong electro-magnetic field radiated from the antenna element is received. Therefore, in general, it is preferable to avoid arranging the mounted component close to the antenna element.

In the mobile wireless terminal 10H of this embodiment, when the display chassis 20 and the main body chassis 30 are in an opened state or in an opened state in tablet shape, the display portion 21 conducts operations (displays information), and therefore, the display circuit portion 120 which drives or controls the display portion 21 conducts operations. However, when the display chassis 20 and the main body chassis 30 are in a closed state, the display portion 21 does not conduct operations, and therefore, the display circuit portion 120 does not conduct operations as well.

On the other hand, regarding a combination of an open/close state of the display chassis 20 and the main body chassis 30, and the antenna element 40A/40B which conducts operations, when the display chassis 20 and the main body chassis 30 are in an opened state, at least the antenna element 40A works, and when the display chassis 20 and the main body chassis 30 are opened in tablet form, the antenna element 40A works. Further, when the display chassis 20 and the main body chassis 30 are in a closed state, the antenna element 40B works in such a constitution.

Therefore, the antenna element 40B works in a condition in which the display chassis 20 and the main body chassis 30 are in a closed state, and in such a condition, the display circuit portion 120 is surely in a stopped state. In such a condition, electro-magnetic influence on the antenna element 40B from the display circuit portion 120 can be minimized. Therefore, it is not necessary to arrange a position on which the display circuit portion 120 is mounted so as to be largely apart from the antenna element 40B in consideration of the electro-magnetic interference, it is simply necessary to avoid a position right under the antenna element 40B, and therefore, there is an advantage in which easiness of a design is improved because there are comparatively less limitations on the arrangement thereof.

It should be noted that the mobile wireless terminal of the present invention is not limited by the above-described embodiment explained with reference to the drawings, and it is possible to include various modified examples in the technical scope of the present invention.

For example, it is possible to appropriately combine constitutions shown in the above-described embodiments.

Further in the above-described embodiments, the antenna elements 40A/40B constituted from slot antennas, 40C/40D constituted from patch antennas and the antenna elements 40E/40F constituted from wire antenna elements are described, and it is possible to apply a constitution in which such antennas are appropriately combined to the first antenna and the second antenna arranged on the main body chassis 20.

Further, in the above-described embodiments, the antenna elements 40A, 40B, 40C, 40D, 40E and 40F and the conductive boards 50A/50B are arranged on the display chassis 20, however, these components can be arranged on the main body chassis 30.

### INDUSTRIAL APPLICABILITY

For example, it is possible to apply the present invention to a mobile wireless terminal having a clamshell type chassis and an antenna, that is, for example, to a cellular phone and a laptop personal computer.

### DESCRIPTION OF THE REFERENCE SYMBOLS

10A-10H . . . mobile wireless terminal
11A, 11B . . . hinge portion
20 . . . display chassis (first chassis)
20a . . . one edge
20b . . . inside surface
20c . . . external surface
21 . . . display portion
30 . . . main body chassis (second chassis)
31 . . . key input portion (input portion)
40A, 40C and 40E . . . antenna element (first antenna)
40B, 40D and 40F . . . antenna element (second antenna)
50A . . . conductive board (first conductive board)
50B . . . conductive board (second conductive board)
60 . . . metallic board
61 . . . slot
90A, 90B . . . antenna switching portion
91 . . . open/close sensor
92 . . . antenna switch
100 . . . measurement portion
110A, 110B . . . metallic wall
120 . . . display circuit

1. A mobile wireless terminal comprising:
a first chassis comprising an antenna portion; and
a second chassis which comprises a metallic portion and which is rotatably connected to an end portion of the first chassis, wherein
the mobile wireless terminal is transformable to at least both a closed state in which the metallic portion is close to the antenna portion when the first and second chassis are overlapped and an opened state in which the metallic portion and the antenna portion are separated by rotatably moving the second chassis from the closed state,
the antenna portion comprises:
a first conductive board when in the closed state, which is arranged on an outer side compared to a first antenna which is on the second chassis while the first conductive board faces the first antenna;
a second antenna which is arranged on the outer side when in the closed state; and
a second conductive board which is arranged on the second chassis and which faces the second antenna.

2. The mobile wireless terminal according to claim 1, wherein
the first chassis comprises a display portion, and
the second chassis comprises an input portion.

3. The mobile wireless terminal according to claim 2, wherein
the first/second antenna and the first/second conductive board are arranged in a manner in which the display portion is sandwiched.

4. The mobile wireless terminal according to claim 1, wherein
a connection between the second chassis and the first chassis is respectively rotable at 360 degrees.

5. The mobile wireless terminal according to claim 1, wherein
at least one of the first antenna and the second antenna is a slot antenna which comprises a narrow slit on a metallic board.

6. The mobile wireless terminal according to claim 1, wherein
at least one of the first antenna and the second antenna is a patch antenna which comprises a radiation element in a plate shape.

7. The mobile wireless terminal according to claim 1, wherein
at least one of the first antenna and the second antenna is a wire antenna in a plate shape comprising a metallic conductive material in a linear shape.

8. The mobile wireless terminal according to claim 1 further comprising an antenna switching portion which selects one of the first antenna and the second antenna based on an open/close state of the first chassis and the second chassis.

9. The mobile wireless terminal according to claim 8, wherein
the antenna switching portion comprises:
a magnet set on one portion of the first chassis and the second chassis;
an open/close sensor which is set on the first chassis or the second chassis that is opposite to the one portion and which detects the open/close state of the first chassis and the second chassis due to a combination with the magnet; and
an antenna switch which selects and switches to one of the first antenna and the second antenna based on a detection signal from the open/close sensor.

10. The mobile wireless terminal according to claim 8, wherein
the antenna switching portion comprises:
a measurement portion which measures amount of reflected electric power of the first and second antennas at a predetermined frequency; and
an antenna switch which selects one of the first and second antennas corresponding to the smaller amount of the electric power based on a signal from the measurement portion.

11. The mobile wireless terminal according to claim 2, further comprising metallic walls which are arranged between the display portion and the first antenna and between the display portion and the second antenna, and which electrically connect between the first conducive board and the first antenna and between the second conductive board and the second antenna.

12. The mobile wireless terminal according to claim 2, further comprising a display circuit portion which controls the display portion, which is arranged between the first antenna and the first conductive board and which is set at a position which is offset or sheared in a lateral direction from a place facing the first antenna.
